(19) United States
(12) Patent Application Publication
(10) Pub. No.: US 2018/0254054 A1
(43) Pub. Date: Sep. 6, 2018

(54) SOUND-RECOGNITION SYSTEM BASED ON A SOUND LANGUAGE AND ASSOCIATED ANNOTATIONS

(71) Applicant: OtoSense Inc., Cambridge, MA (US)

(72) Inventors: Thor C. Whalen, Menlo Park, CA (US); Sebastien J.V. Christian, Mountain View, CA (US)

(73) Assignee: OtoSense Inc., Cambridge, MA (US)

(21) Appl. No.: 15/647,798

(22) Filed: Jul. 12, 2017

Related U.S. Application Data
(63) Continuation-in-part of application No. 15/458,412, filed on Mar. 14, 2017.
(60) Provisional application No. 62/466,221, filed on Mar. 2, 2017.

(51) Int. Cl. G10L 25/27; G10L 25/45; G10L 25/51; G10L 21/0308; G10L 25/18

(52) U.S. Cl. CPC G10L 25/27; G10L 25/45; G10L 25/18; G10L 21/0308; G10L 25/51

(57) ABSTRACT

The disclosed embodiments provide a system for recognizing a sound event in raw sound. During operation, the system receives the raw sound, wherein the raw sound comprises a sequence of digital samples of sound. Next, the system segments the raw sound into a sequence of tiles, wherein each tile comprises a set of consecutive digital samples. The system then converts the sequence of tiles into a sequence of snips, wherein each snip includes a symbol representing an associated tile in the sequence of tiles. Next, the system generates annotations for the sequence of snips and the raw sound, wherein each annotation specifies a property associated with one or more snips in the sequence of snips or the raw sound. Finally, the system recognizes the sound event based on the generated annotations.

### RELATED APPLICATIONS

This application is a continuation-in-part of pending U.S. patent application Ser. No. 15/458,412, entitled “Syntactic System for Sound Recognition” by inventors Thor C. Whalen and Sebastien J. V. Christian, Attorney Docket Number OTOS16-1002, filed on 14 Mar. 2017, the contents of which are incorporated by reference herein. This application also claims priority under 35 U.S.C. § 119(e) to U.S. Provisional Application Ser. No. 62/466,221, entitled “SLANG—An Annotated Language of Sound,” by inventors Thor C. Whalen and Sebastien J. V. Christian, Attorney Docket Number OTOS17-1001PSP, filed on 2 Mar. 2017, the contents of which are likewise incorporated by reference herein.

### FIELD

The disclosed embodiments generally relate to the design of an automated system for recognizing sounds. More specifically, the disclosed embodiments relate to the design of an automated sound-recognition system that uses syntactic pattern mining and grammar induction to transform audio streams into structures of annotated and linked symbols.

### RELATED ART

Recent advances in computing technology have made it possible for computer systems to automatically recognize sounds, such as the sound of a gunshot, or the sound of a baby crying. This has led to the development of automated sound-recognition systems for detecting corresponding events, such as gunshot-detection systems and baby-monitoring systems. Existing sound-recognition systems typically operate by performing computationally expensive operations, such as time-warping sequences of sound samples to match known sound patterns. Moreover, these existing sound-recognition systems typically store sounds in raw form as sequences of sound samples, which are not searchable. Some systems compute indices for features of chunks of sound to make the sounds searchable, but extra-chunk and intra-chunk subtleties are lost.

Hence, what is needed is a system that automatically recognizes sounds without the above-described drawbacks of existing sound-recognition systems.

### SUMMARY

The disclosed embodiments provide a system for recognizing a sound event in raw sound using a “syntactic approach.” This syntactic approach encodes structure through a system of annotations. An annotation associates a pattern with properties thereof. A pattern could pertain to specific audio segments or to (patterns of) patterns themselves and annotations can be created explicitly by a user or generated by the system. Annotations that pertain to specific audio segments are called “grounded patterns.” A user creates grounded annotations created by tagging specific audio segments with semantic information, but a user can also label or link annotations themselves (for example, by specifying synonyms, ontologies or event patterns). Similarly, the system itself automatically creates annotations that markup sound segment with acoustic information or patterns that link annotations together. One frequently used annotation property type is the “symbol,” i.e. a categorical identifier drawn from a finite set of symbols. This is the standard in grammar induction methods. Though symbols are extensively used in our syntactic approach, numerical and structural properties are also used when necessary (where a finite set of categorical symbols won't do). Often numerical properties (such as acoustic features) are used as intermediate values that guide the subsequent association to a symbol. During operation, the system receives the raw sound, wherein the raw sound comprises a sequence of digital samples of sound. During the first fundamental phase of the annotation process, the system segments the raw sound into a sequence of tiles, wherein each tile comprises a set of consecutive digital samples. The system then converts the sequence of tiles into a sequence of snips, wherein each snip includes a symbol representing an associated tile in the sequence of tiles. Next, the system generates annotations for the sequence of snips and the raw sound, wherein each annotation specifies a property associated with one or more snips in the sequence of snips or the raw sound. Finally, the system recognizes the sound event based on the generated annotations.

In some embodiments, converting the sequence of tiles into the sequence of snips involves: identifying tile features for each tile in the sequence of tiles; performing a clustering operation based on the tile features to identify clusters of tiles and to associate each tile with a cluster; associating each identified cluster with a unique symbol; and representing the sequence of tiles as a sequence of symbols representing clusters, wherein the symbols are associated with individual tiles in the sequence of tiles.

In some embodiments, the sequence of tiles includes one or more of the following: overlapping tiles; non-overlapping tiles; tiles having variable sizes; and one or more gaps between tiles in the sequence of tiles, wherein each gap comprises a segment of the raw sound that is not covered by a tile.

In some embodiments, annotating the sequence of snips involves: generating grounded annotations, which are associated with specific segments of raw sound; and generating higher-level annotations, which are associated with lower-level annotations.

In some embodiments, an annotation can include an acoustic annotation, which specifies an acoustic property associated with a sound feature.

In some embodiments, an annotation can include a semantic tag.

In some embodiments, an annotation can include a higher-level semantic tag, which is associated with one or more lower-level semantic tags.

In some embodiments, recognizing the sound event based on the generated annotations additionally involves considering other sensor inputs, which are associated with the raw sound.

In some embodiments, an annotation for each snip includes a centroid distance parameter, which specifies a distance between a feature vector for a tile associated with the snip and a mean feature vector for all tiles associated with the snip. In these embodiments, the system detects an anomaly in the sequence of snips if the centroid distance for one or more snips in the sequence of snips exceeds a threshold value.

In some embodiments, an annotation for each snip includes a rareness score that specifies a rareness of the snip. In these embodiments, the system detects an anomaly in the sequence of snips if rareness scores for a proximate set of snips in the sequence of snips exceed a threshold value.

### BRIEF DESCRIPTION OF THE FIGURES

FIG. 1 illustrates a computing environment in accordance with the disclosed embodiments.

FIG. 2 illustrates a model-creation system in accordance with the disclosed embodiments.

FIG. 3A presents a diagram illustrating an exemplary sound-recognition process in accordance with the disclosed embodiments.

FIG. 3B presents a diagram illustrating another sound-recognition process in accordance with the disclosed embodiments.

FIG. 4A illustrates the snipping process with non-overlapping, fixed-sized tiles in accordance with the disclosed embodiments.

FIG. 4B illustrates the snipping process with overlapping, fixed-sized tiles in accordance with the disclosed embodiments.

FIG. 4C illustrates the snipping process with non-overlapping, variable-sized tiles in accordance with the disclosed embodiments.

FIG. 5A presents a flow chart illustrating a process for converting raw sound into a sequence of snips associated with a sequence of tiles in accordance with the disclosed embodiments.

FIG. 5B presents a flow chart illustrating a process for generating semantic tags from a sequence of symbols in accordance with the disclosed embodiments.

FIG. 5C presents a flow chart illustrating a technique for normalizing and reducing the dimensionality of the tiles in accordance with the disclosed embodiments.

FIG. 6 illustrates how a PCA operation is applied to a column in a matrix containing spectrogram slices in accordance with the disclosed embodiments.

FIG. 7 illustrates an exemplary sound-processing pipeline in accordance with the disclosed embodiments.

FIG. 8A illustrates an annotator in accordance with the disclosed embodiments.

FIG. 8B illustrates the structure of the annotation process in accordance with the disclosed embodiments.

FIG. 8C illustrates an exemplary annotator composition in accordance with the disclosed embodiments.

FIG. 9A illustrates an exemplary output of the annotator composition illustrated in FIG. 8C in accordance with the disclosed embodiments.

FIG. 9B illustrates an exemplary sequence of symbols in accordance with the disclosed embodiments.

FIG. 10 presents a flow chart illustrating the process of recognizing a sound event in accordance with the disclosed embodiments.

FIG. 11 presents a flow chart illustrating the process of detecting an anomaly in accordance with the disclosed embodiments.

### DETAILED DESCRIPTION

The following description is presented to enable any person skilled in the art to make and use the present embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the present embodiments are not limited to the embodiments shown, but are to be accorded the widest scope consistent with the principles and features disclosed herein.

The data structures and code described in this detailed description are typically stored on a computer-readable storage medium, which may be any device or medium that can store code and/or data for use by a computer system. The computer-readable storage medium includes, but is not limited to, volatile memory, non-volatile memory, magnetic and optical storage devices such as disk drives, magnetic tape, CDs (compact discs), DVDs (digital versatile discs or digital video discs), or other media capable of storing computer-readable media now known or later developed.

The methods and processes described in the detailed description section can be embodied as code and/or data, which can be stored in a computer-readable storage medium as described above. When a computer system reads and executes the code and/or data stored on the computer-readable storage medium, the computer system performs the methods and processes embodied as data structures and code and stored within the computer-readable storage medium. Furthermore, the methods and processes described below can be included in hardware modules. For example, the hardware modules can include, but are not limited to, application-specific integrated circuit (ASIC) chips, field-programmable gate arrays (FPGAs), and other programmable-logic devices now known or later developed. When the hardware modules are activated, the hardware modules perform the methods and processes included within the hardware modules.

### General Approach

In this disclosure, we describe a system that transforms sound into a “sound language” representation, which facilitates performing a number of operations on the sound, such as: general sound recognition; information retrieval; multi-level sound-generating activity detection; and classification. By the term “language” we mean both a formal and symbolic system for communication. During operation, the system processes an audio stream using a multi-level computational flow, which transforms the audio stream into a structure comprising interconnected informational units: from lower-level descriptors of the raw audio signals, to aggregates of these descriptors, to higher-level humanly interpretable classifications of sound facets, sound-generating sources or even sound-generating activities.

The system represents sounds using a language, complete with an alphabet, words, structures, and interpretations, so that a connection can be made with semantic representations. The system achieves this through a framework of annotators that associate segments of sound to properties thereof, and further annotators are also used to link annotations or sequences and collections thereof to properties. A tiling component is the entry annotator of the system that subdivides an audio stream into tiles. Tile feature computation is an annotator that associates each tile with features thereof. The clustering of tile features is an annotator that maps tile features to symbols (called “snips”—for “sound nip”) drawn from a finite set of symbols. Thus, the snipping annotator, which is a combination of the tiling, feature-computation, and clustering, annotates an audio stream into a stream of tiles annotated by snips. Furthermore, annotators annotate subsequences of tiles by mining the snip sequence for patterns. These bottom-up annotators create a language from an audio stream by generating a sequence of symbols (letters) as well as a structuring thereof, akin to words, phrases, and syntax in a natural language. Note that annotations can also be supervised, wherein a user of the system manually annotates segments of sounds, associating them with semantic information.

In a sound-recognition system that uses a sound language (as in natural-language processing), “words” are a means to an end: producing meaning. That is, the connection between signal processing and semantics is bidirectional. We represent and structure sound in a language-like organization, which expresses the acoustical content of the sound and links it to its associated semantics. Conversely, we can use targeted semantic categories of sound-generating activities to inform a language-like representation and structuring of the acoustical content, enabling the system to efficiently and effectively express the semantics of interest for the sound.

Before describing details of this sound-recognition system, we first describe a computing system on which the sound-recognition system operates.

### Computing Environment

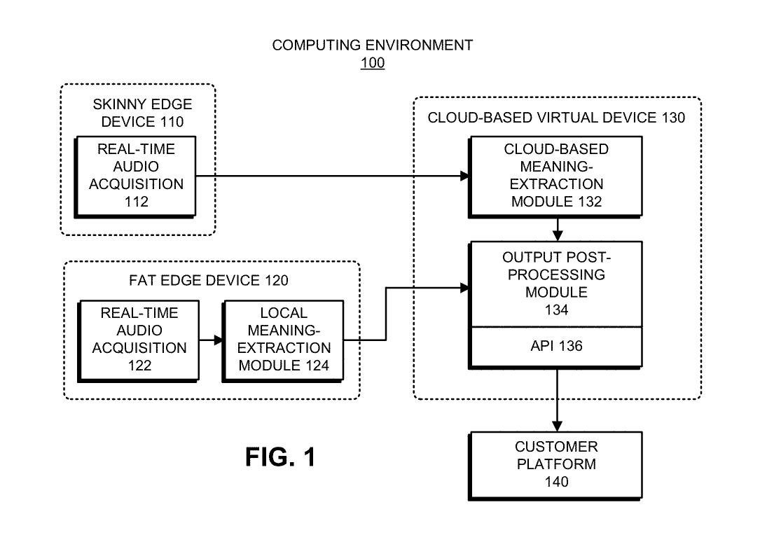

FIG. 1 illustrates a computing environment 100 in accordance with the disclosed embodiments. Computing environment 100 includes two types of device that can acquire sound, including a skinny edge device 110, such as a live-streaming camera, and a fat edge device 120, such as a smartphone or a tablet. Skinny edge device 110 includes a real-time audio acquisition unit 112, which can acquire and digitize an audio signal. However, skinny edge device 110 provides only limited computing power, so the audio signals are pushed to a cloud-based meaning-extraction module 132 inside a cloud-based virtual device 130 to perform meaning-extraction operations. Note that cloud-based virtual device 130 comprises a set of software resources that can be hosted on a remote enterprise-computing system.

Fat edge device 120 also includes a real-time audio acquisition unit 122, which can acquire and digitize an audio signal. However, in contrast to skinny edge device 110, fat edge device 120 possesses more internal computing power, so the audio signals can be processed locally in a local meaning-extraction module 124.

The output from both local meaning-extraction module 124 and cloud-based meaning-extraction module 132 feeds into an output post-processing module 134, which is also located inside cloud-based virtual device 130. This output post-processing module 134 provides an application programming interface (API) 136, which can be used to communicate results produced by the sound-recognition process to a customer platform 140.

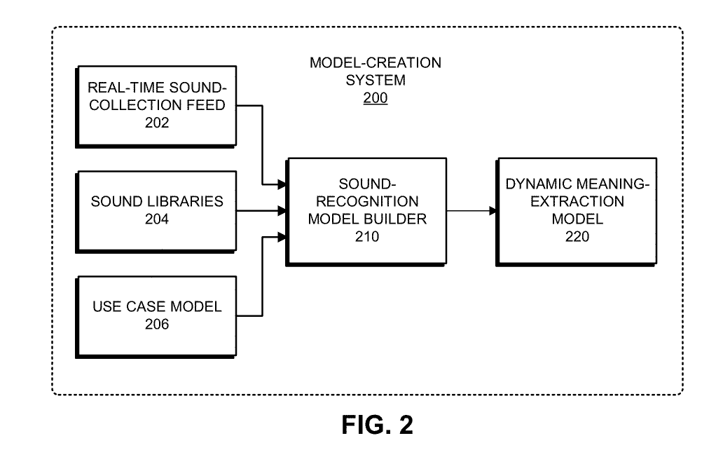

Referring to the model-creation system 200 illustrated in FIG. 2, both local meaning-extraction module 124 and cloud-based meaning-extraction module 132 make use of a dynamic meaning-extraction model 220, which is created by a sound-recognition model builder unit 210. This sound-recognition model builder unit 210 constructs and periodically updates dynamic meaning-extraction model 220 based on audio streams obtained from a real-time sound-collection feed 202 and from one or more sound libraries 204 and a use case model 206.

### Sound-Recognition Based on Sound Features

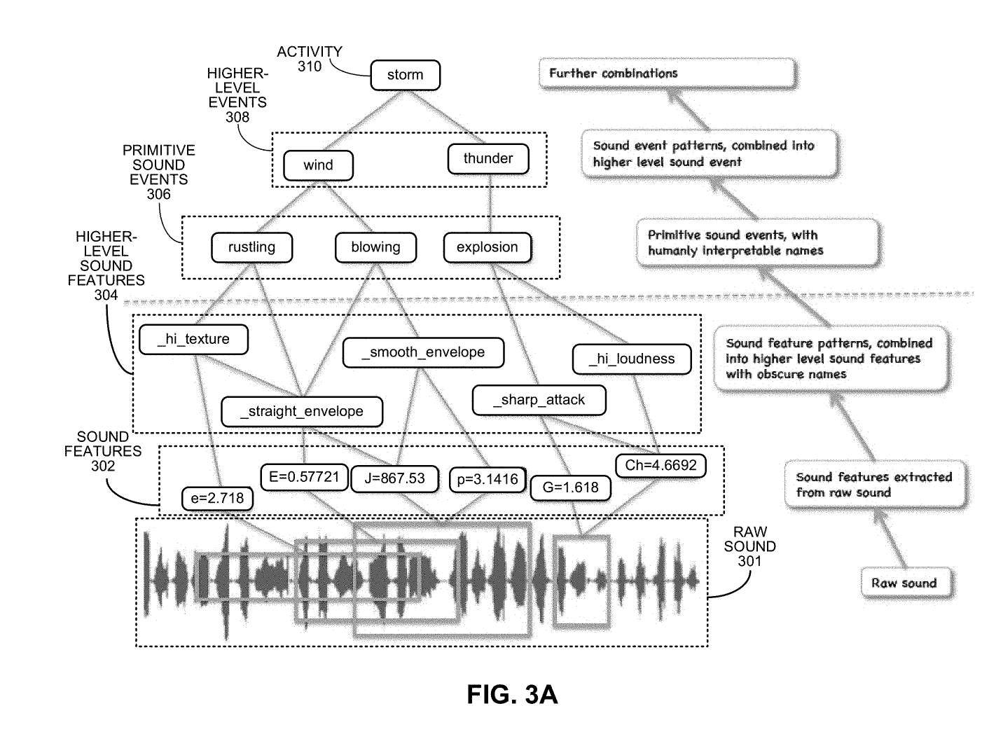

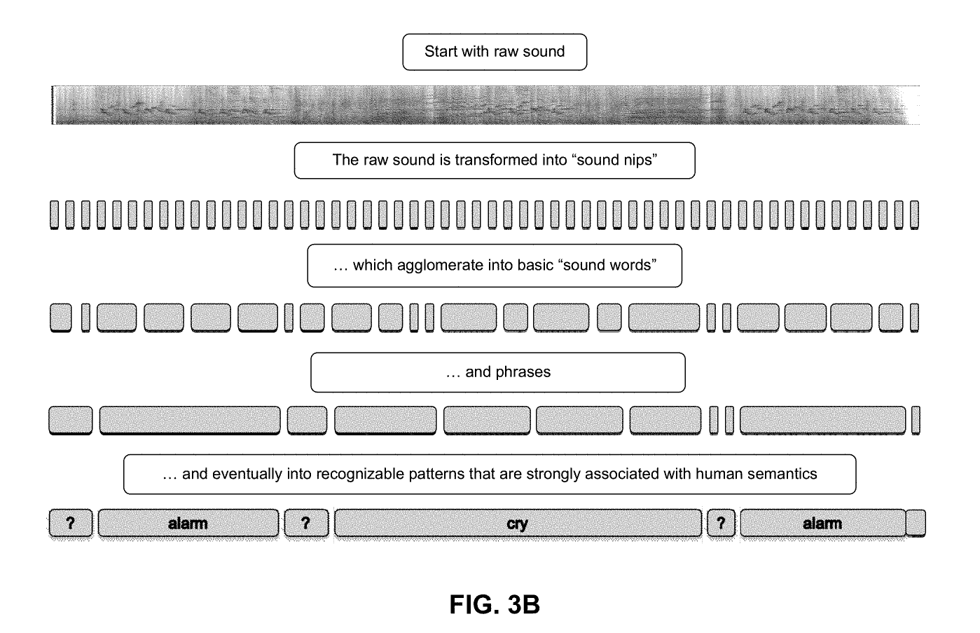

FIG. 3A presents a diagram illustrating an exemplary sound-recognition process that first converts raw sound into “sound features,” which are hierarchically combined and associated with semantic labels. Note that each of these sound features comprises a measurable characteristic for a window of consecutive sound samples. (For example, see U.S. patent application Ser. No. 15/256,236, entitled “Employing User Input to Facilitate Inferential Sound Recognition Based on Patterns of Sound Primitives” by the same inventors as the instant application, filed on 2 Sep. 2016, which is hereby incorporated herein by reference.) The system starts with an audio stream comprising raw sound 301. Next, the system extracts a set of sound features 302 from the raw sound 301, wherein each sound feature is associated with a numerical value. The system then combines patterns of sound features into higher-level sound features 304, such as “_smooth_envelope,” or “_sharp_attack.” These higher-level sound features 304 are subsequently combined into primitive sound events 306, which are associated with semantic labels, and have a meaning that is understandable to people, such as a “rustling,” a “blowing” or an “explosion.” Next, these primitive sound events 306 are combined into higher-level events 308. For example, rustling and blowing sounds can be combined into wind, and an explosion can be correlated with thunder. Finally, the higher-level sound events wind and thunder 308 can be combined into a recognized activity 310, such as a storm.

### Sound-Recognition Based on Snips

FIG. 3B presents a diagram illustrating a sound-recognition process that operates on snips (“sound nips”) in accordance with the disclosed embodiments. As illustrated in FIG. 3B, the system starts with raw sound. Next, the raw sound is transformed into snips.

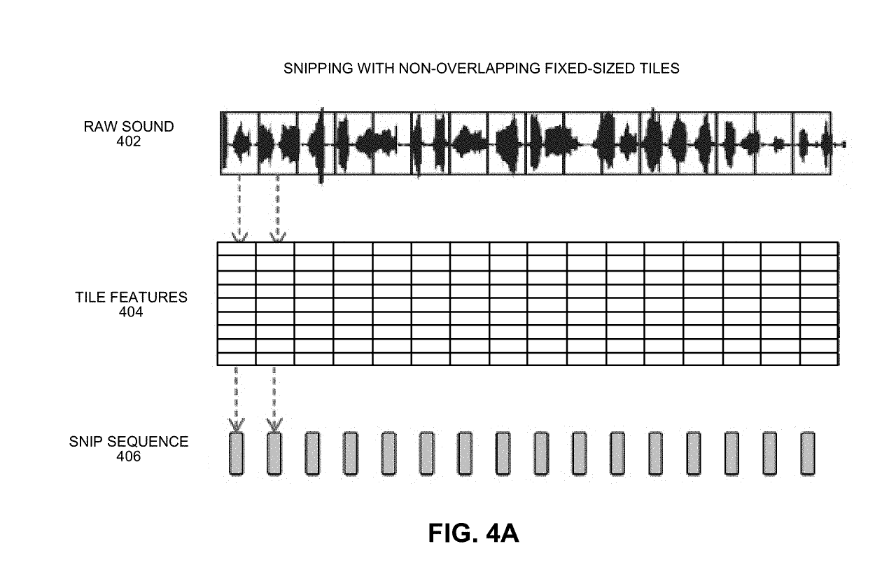

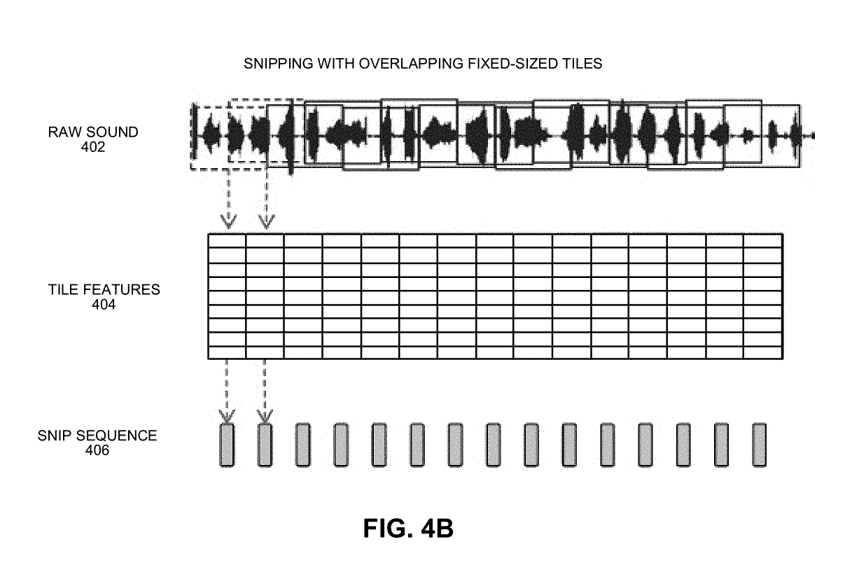

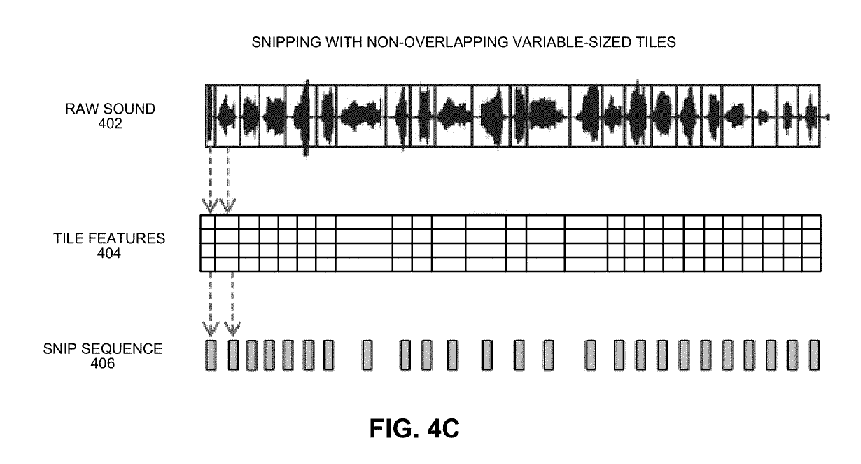

This process of transforming the raw sound into snips is illustrated in more detail in FIG. 4A. First, the system converts the raw sound 402 into a sequence of tile features 404, for example spectrogram slices wherein each spectrogram slice comprises a set of intensity values for a set of frequency bands measured over a time interval. Next, the system uses a supervised and unsupervised learning process to associate each tile with a symbol to form a snip sequence 406. Note that the snipping process can use overlapping or non-overlapping tiles and fixed-sized or variable-sized tiles as is illustrated in FIGS. 4A-4C. The snipping process can also create gaps between tiles, wherein each gap comprises a segment of the raw sound that is not covered by a tile.

Referring back to FIG. 3B, after the snipping process completes, the system agglomerates the snips into “sound words,” which comprise patterns of symbols that are defined by a learned vocabulary. These sound words are then combined into phrases, and eventually into recognizable patterns, which are associated with human semantic labels.

### Example of a Simple Sound Language

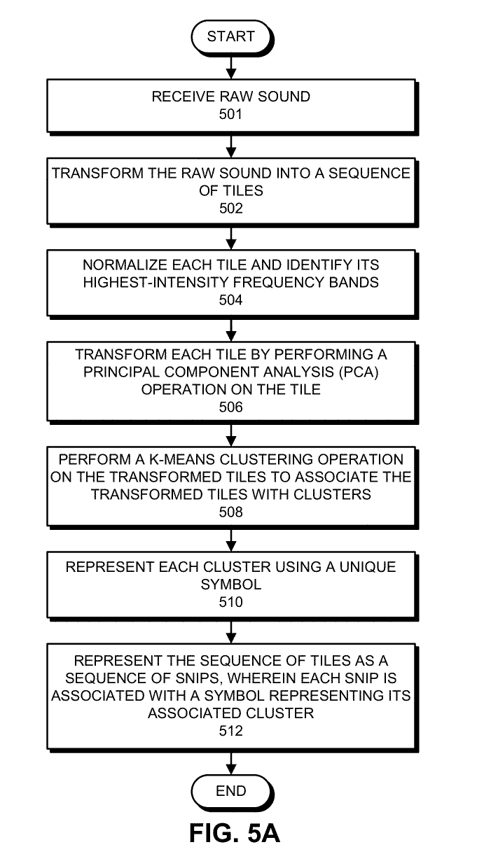

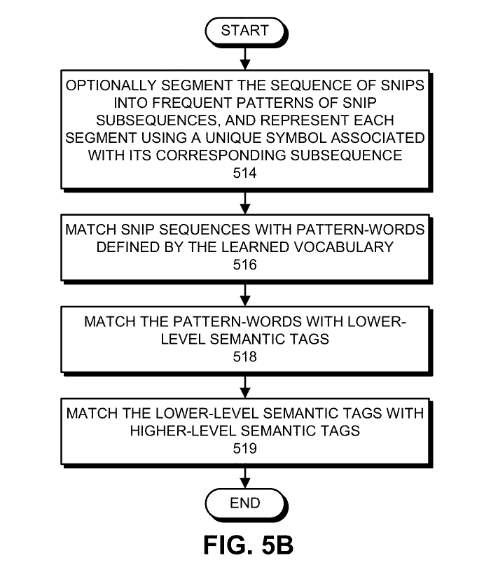

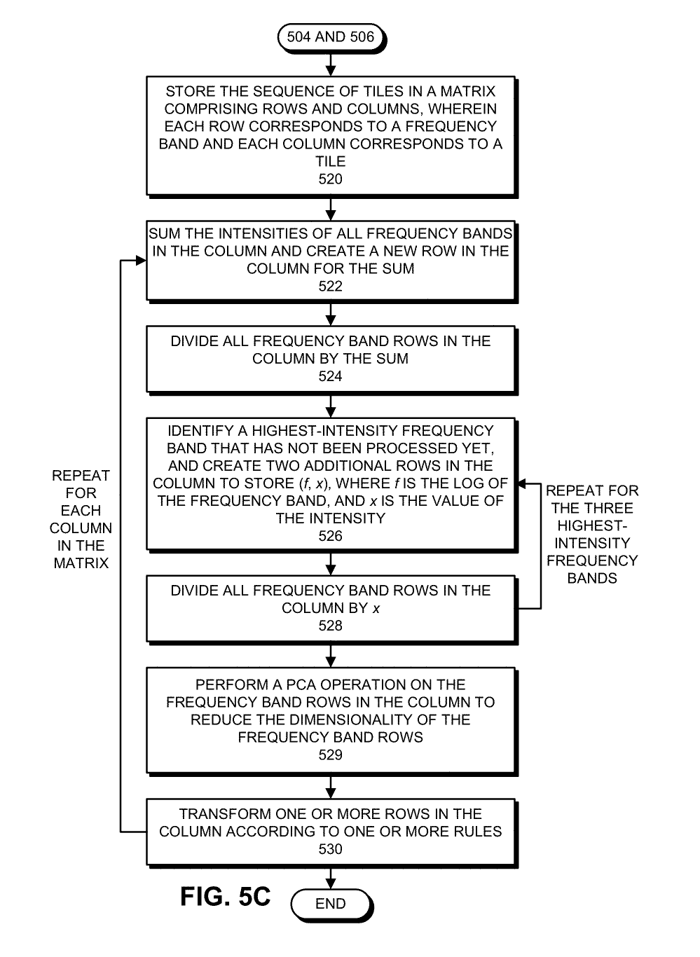

FIG. 5A presents a flow chart illustrating a process for converting raw sound into a sequence of snips associated with tiles in accordance with the disclosed embodiments. First, the system receives the raw sound (step 501), wherein the raw sound comprises a sequence of digital samples representing intensity values for a sound. The system then transforms the raw sound into a sequence of tiles (step 502), wherein each tile is associated with a “spectrogram slice” comprising a set of intensity values for a set of frequency bands (e.g., 128 frequency bands) measured over a time interval (e.g., 46 milliseconds). Next, the system normalizes each tile and identifies its highest-intensity frequency bands (step 504). The system then transforms each normalized tile by performing a principal component analysis (PCA) operation on the tile (step 506). After the PCA operation is complete, the system performs a k-means clustering operation on the transformed tiles to associate the transformed tiles with centroids of the clusters (step 508). The system also represents each cluster using a unique symbol (step 510). For example, there might exist 8,000 clusters, in which case the system will use 8,000 unique symbols to represent the 8,000 clusters. Finally, the system represents the sequence of tiles as a sequence of snips, wherein each snip is associated with a symbol representing its associated cluster (step 512).

Note that the sequence of snips can be used to reconstruct the sound. However, some accuracy will be lost during the reconstruction process because the center of a centroid is likely to differ somewhat from the actual tile that mapped to the centroid. Also note that the sequence of snips is much more compact than the original sequence of tiles, and the sequence of snips can be stored in a canonical representation, such as Unicode. Moreover, the sequence of snips is easy to search, for example by using regular expressions. Also, by using snips we can generate higher-level structures, which can be associated with semantic tags as is described in more detail below.

FIG. 5B presents a flow chart illustrating a process for generating semantic tags from a sequence of symbols in accordance with the disclosed embodiments. In an optional first step, the system segments the sequence of snips into frequent patterns of snip subsequences, and represents each segment using a unique symbol associated with its corresponding subsequence (step 514). In general, any type of segmentation technique can be used. For example, we can look for commonly occurring short subsequences of snips (such as bigrams, trigrams, quadgrams, etc.) and can segment the sequence of snips based on these commonly occurring short subsequences. More generally, each snip is mapped to a vector of a weighted related snip, and areas of high density in this vector space are detected and annotated (becoming the pattern-words of our language). Next, the system matches snip sequences with pattern-words defined by this learned vocabulary (step 516). The system then matches the pattern-words with lower-level semantic tags (step 518). Finally, the system matches the lower-level semantic tags with higher-level semantic tags (step 519).

FIG. 5C presents a flow chart illustrating a technique for normalizing tiles and reducing the dimensionality of the normalized tiles in accordance with the disclosed embodiments. At the start of this process, the system first stores the sequence of tiles in a matrix comprising rows and columns, wherein each row corresponds to a frequency band and each column corresponds to a tile (step 520).

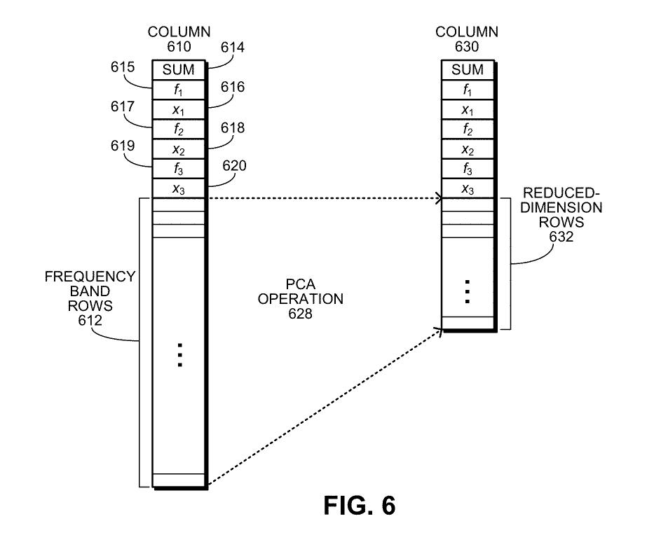

The system then repeats the following operations for all columns in the matrix. First, the system sums the intensities of all of the frequency bands in the column and creates a new row in the column for the sum (step 522). (See FIG. 6, which illustrates a column 610 containing a set of frequency band rows 612, and also a row-entry for the sum of the intensities of all the frequency bands 614.) Next, the system divides all of the frequency band rows 612 in the column by the sum 614 (step 524).

The system then repeats the following steps for the three highest-intensity frequency bands. The system first identifies the highest-intensity frequency band that has not been processed yet, and creates two additional rows in the column to store (f, x), where f is the log of the frequency band, and x is the value of the intensity (step 526). (See the six row entries 615-620 in FIG. 6, which store f and x values for the three highest-intensity bands, namely (f₁, x₁, f₂, x₂, f₃, and x₃). The system also divides all the frequency band rows in the column by x (step 528).

After the three highest-intensity frequency bands are processed, the system performs a PCA operation on the frequency band rows in the column to reduce the dimensionality of the frequency band rows (step 529). (See PCA operation 628 in FIG. 6, which reduces the frequency band rows 612 into a smaller number of reduced dimension rows 632 in a reduced column 630.) Finally, the system transforms one or more rows in the column according to one or more rules (step 530). For example, the system can increase the value stored in the sum row-entry 614 because that stores the sum of the intensities, so the sum is more significant in subsequent processing.

### Sound-Processing Pipeline

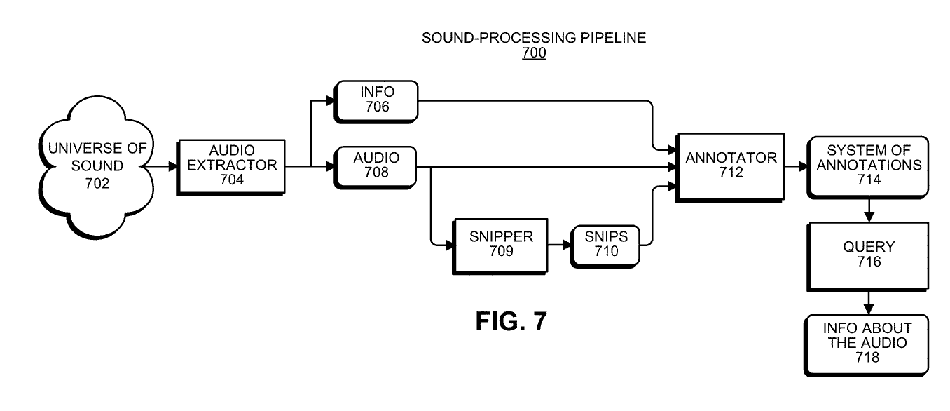

FIG. 7 illustrates a sound-processing pipeline 700 in accordance with the disclosed embodiments. At the start of pipeline 700, an audio extractor 704 extracts some audio 708 and associated information 706 from a universe of sound 702. This extraction process can involve a number of operations, such as de-noising, normalizing, and resampling the audio 708 and structuring information 706 to facilitate subsequent processing operations. Note that information 706 can include contextual information, such as sound references, microphone specifications, time and date, locations, tags, or any unstructured or structured information that might be associated with the audio. Information 706 can also include sensor inputs, which are correlated with the sound, such as inputs from a voltage sensor or a light sensor.

Next, a snipper 709 segments the audio stream into small segments called “tiles,” and maps them to symbols of a finite alphabet to form snips 710. Thus, the snipper 709 transforms an audio stream into a stream of symbols, which are represented as a sequence of snips.

Next, the snips 710 along with information 706 and the audio 708 are fed into an annotator 712, which generates a system of annotations 714 for the sequence of snips and the raw sound, wherein each annotation specifies a property associated with one or more snips in the sequence of snips or the raw sound. Note that these annotations comprise a cornerstone of the sound language. In fact, the sound language is defined through the structure that emerges from associated annotations. In fact, snips are themselves annotations because they denominate segments of sound that are grouped based on some acoustic similarity measure. Other higher-level annotations can define relationships between snip sequences, acoustics, and semantics.

Finally, the system of annotations 714 can be queried 716 to obtain information about the audio 718, which can relate to acoustical features or semantic characteristics of the audio, and which can be inferred from the overlap of acoustical and semantic annotations.

### Annotator

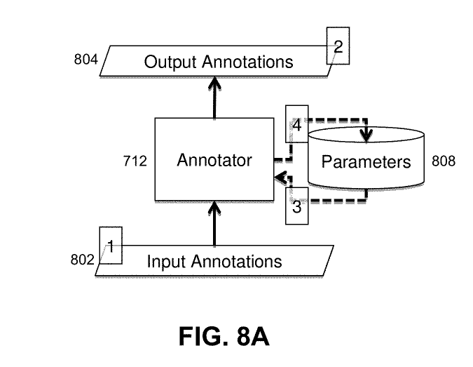

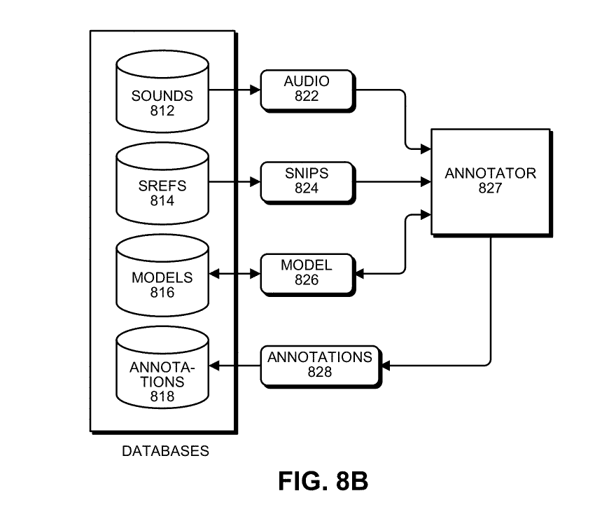

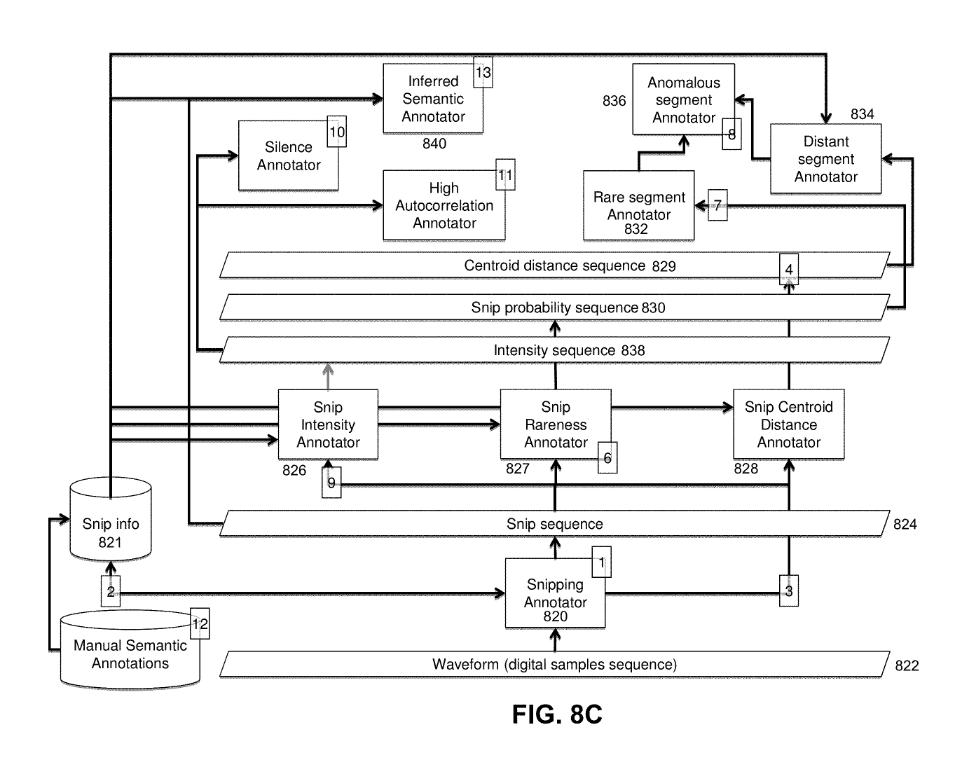

FIG. 8A illustrates an exemplary annotator 712, which is used to annotate snips and segments in accordance with the disclosed embodiments. More specifically, FIG. 8A illustrates how the annotator 712 receives input annotations 802, and produces output annotations 804 based on various parameters 808.

More specifically, FIG. 8B illustrates the structure of the annotation process in accordance with the disclosed embodiments. During this process, snips 824 are fed into an annotator 827. Note that annotator 827 can be in “learning mode,” wherein it does not output anything but is constructing an internal representation of the sound corpus, or it can be in “production mode,” wherein it determines if any segment of the snips matches a pattern it is meant to annotate. Also note that snips are associated with sound references (srefs) from an srefs database 814, wherein an sref comprises a reference into an audio source. Annotator 827 can additionally receive audio 822 from a sounds database 812. When a model for recognizing annotations 826 is learned, it can be stored in a models database 816 for subsequent use. When the model is subsequently used, it is retrieved from models database 816 and is applied to query inputs.

The resulting annotations 828 are stored in an annotations database 818. Note that an annotation is a property directly or indirectly associated with one or several segments of audio. When an annotation is directly associated with a specific segment of audio, it is called a “grounded” annotation. Grounded annotations can be represented by a set of four parameters (sref, ft, lt, properties), wherein: sref is a reference to an audio source; ft is a “first timestamp” or a “first tile;” and lt is a “last timestamp” or “last tile.” Note that sref, ft and lt identify a specific segment of the source sound the annotation is referring to. Finally, the “properties” parameter comprises data associated with the annotation, which can include anything from simple text, to a complex object providing information about the audio segment. The most obvious type of annotation includes user-entered annotations. A user can listen to a sound, select a segment of it, and then tag it to describe what is happening in the segment. This is an example of a “semantic annotation.” Another type of annotation is an “acoustic annotation.” Acoustic annotations can be automatically computed by the annotator 827, which processes the audio 822 and/or the snips 824, and outputs one or more annotations 828 for segments of sound, which are determined to be “interesting” enough.

FIG. 8C illustrates an exemplary annotator composition in accordance with the disclosed embodiments. This figure illustrates how the system starts with waveforms, and then produces tile snips (which can be thought of as the first annotation of the waveform), and then tile/snip annotations and segment annotations. More specifically referring to FIG. 8C, the snipping annotator 820 (also referred to as “the snipper”), whose parameters are assumed to have already been learned, takes an input waveform 822, extracts tiles of consecutive waveform samples, computes a feature vector for that tile, finds the snip that is closest to that feature vector, and assigns that snip to it (that is, the property of the tile is the snip). Thus, the snipping annotator 820 essentially produces a sequence of tile snips 824 from the waveform 822.

As the snipping annotator 820 consumes and tiles waveforms, useful statistics are maintained in the snip info database 821. In particular, the snipping annotator 820 updates a snip count and a mean and variance of the distance of the encountered tile feature vector to the feature centroid of snip that the tile was assigned to. This information is used by downstream annotators.

Note that the feature vector and snip of each tile extracted by the snipping annotator 820 is fed to the snip centroid distance annotator 828. The snip centroid distance annotator 828 computes the distance of the tile feature vector to the snip centroid, producing a sequence of “centroid distance” annotations 829 for each tile. Using the mean and variance distance to a snip's feature centroid, the distant segment annotator 834 decides when a window of tiles has enough accumulated distance to annotate it. These segment annotations reflect how anomalous the segment is, or detect when segments are not well represented by the current snipping rules. Using the (constantly updating) snip counts of snip information, the snip rareness annotator 827 generates a sequence of snip probabilities 830 from the sequence of tile snips 824. The rare segment annotator 832 detects when there exists a high density of rare snips and generates annotations for rare segments. The anomalous segment annotator 836 aggregates the information received from the distant segment annotator 834 and the rare segment annotator 832 to decide which segments to mark as “anomalous,” along with a value indicating how anomalous the segment is.

Note that the snip information includes the feature centroid of each snip, from which can be extracted or computed the (mean) intensity for that snip. The snip intensity annotator 826 takes the sequence of snips and generates a sequence of intensities 838. The intensity sequence 838 is used to detect and annotate segments that are consistently low in intensity (e.g., “silent”). The intensity sequence 838 is also used to detect and annotate segments that are over a given threshold of (intensity) autocorrelation. These annotations are marked with a value indicating the autocorrelation level.

The audio source is provided with semantic information, and specific segments can be marked with words describing their contents and categories. These are absorbed, stored in the database (as annotations), the co-occurrence snips and categories are counted, and the likelihood of the categories associated with each snip in the snip information data is computed. Using the category likelihoods associated with the snips, the inferred semantic annotator 840 marks segments that have a high likelihood of being associated with any of the targeted categories.

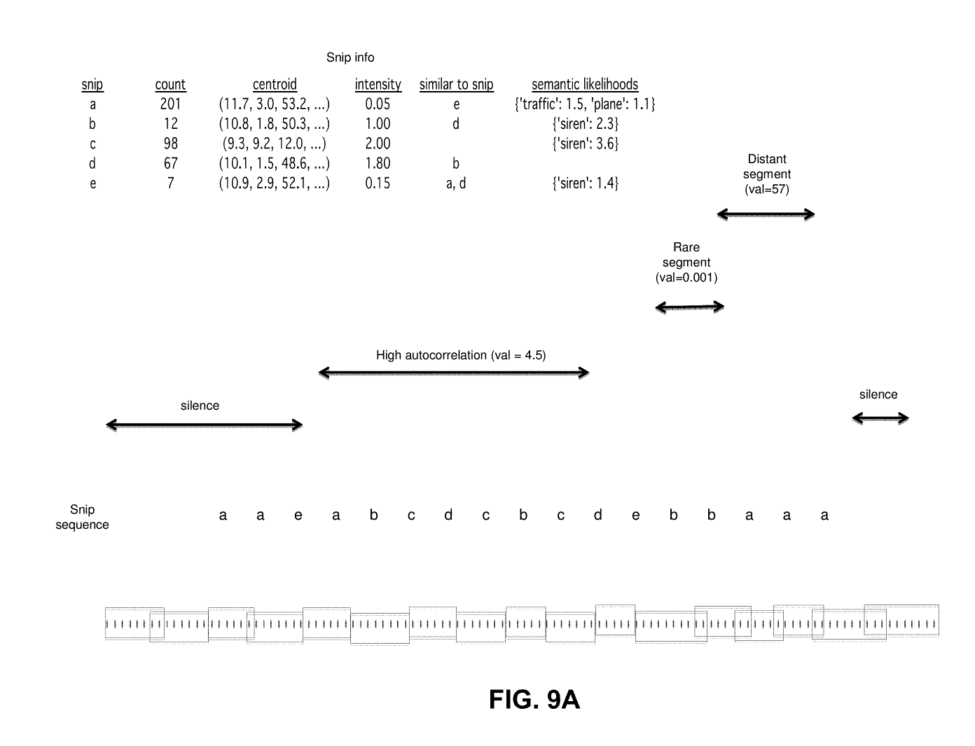

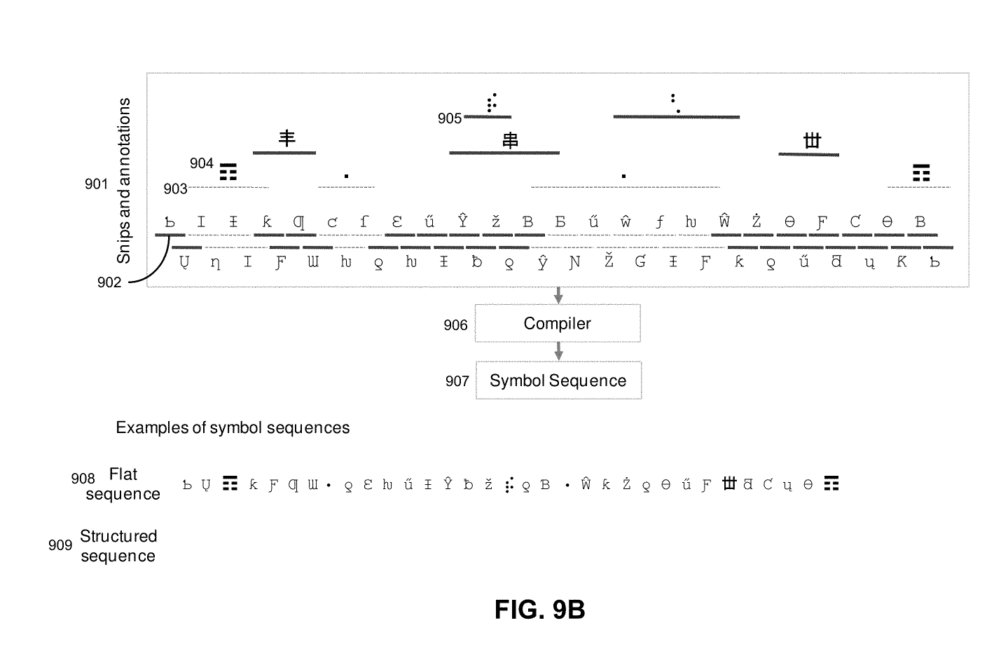

FIG. 9 illustrates an exemplary output of an annotator composition illustrated in FIG. 8C in accordance with the disclosed embodiments. FIG. 9 also includes a table illustrating the “snip info” that is used to create each annotation.

### Sequences of Symbols

In order to apply text mining and natural-language processing techniques to audio streams, we transform audio streams into a sequence of symbols. The tile snips are themselves a sequence of symbols, but it is useful to also include the information that other annotations provide. To do so, we feed chosen grounded annotations through a component that outputs a corresponding sequence of symbols. These symbols contain snips themselves, but also other small sequences of snips that obey a given pattern and should be considered as a unit of interest. Three aspects need to be considered in this transformation: categorization, reduction, and structuring. Categorization is the process of associating an annotation to a symbol if this annotation does not already have a categorical value (like tile snips do). Reduction is the process of choosing what symbols will appear in the output out of all symbols provided by the categorized annotations. Structuring is the process that decides how these symbols are ordered and what additional symbols will be used to structure the sequence (such as space, punctuation or part of speech tagging in natural language, or any special symbols of a markup language). In light of this, all mention of snip sequences and symbol sequences in the present disclosure are interchangeable.

In reference to FIG. 9B, 901 is the set of input annotations for a sound, comprised of the tile snips 902, some “word snips” annotations 902, and two other annotation types 904 and 905. These annotations are fed to a compiler 906 that has (categorization, reduction and structuring) rules that specify how to produce a symbol sequence 907 from the input 901. All annotations in 901 have already been categorized. We also show two examples of outputs. A flat sequence output 908 that has the reduction rule that if a “snip word” is present, none of its composing snips are output—only the symbol for the word is. Both snip word annotations and the snips they cover are shown with thin dashed lines in 901. The compiler also has a structuring rule specifying that if the end of an annotated segment B is later than another segment A, that the symbol of A should be first in the sequence, and that the length of the segment (greater last) is the decider of ties therein. This flat sequence is sufficient for many text-mining techniques such as bag-of-words, topic analysis, and anomaly detection. The second example, which is useful for more advanced natural language processing techniques, is a “structured sequence” example, using three special symbols—(, -, and)—to encode structure using the (ANNOTATION_SYMBOL—ANNOTATED_CONTENTS) pattern.

### Operations on Sequences of Symbols

After a set of sounds is converted into corresponding sequences of symbols, various operations can be performed on the sequences. For example, we can generate a histogram, which specifies the number of times each symbol occurs in the sound. For example, suppose we start with a collection of n “sounds,” wherein each sound comprises an audio signal that is between one second and several minutes in length. Next, we convert each of these sounds into a sequence of symbols (or words) using the process outlined above. Then, we count the number of times each symbol occurs in these sounds, and we store these counts in a “count matrix,” which includes a row for each symbol (or word) and a column for each sound. Next, for a given sound, we can identify the other sounds that are similar to it. This can be accomplished by considering each column in the count matrix to be a vector and performing “cosine similarity” computations between a vector for the given sound and vectors for the other sounds in the count matrix. After we identify the closest sounds, we can examine semantic tags associated with the closest sounds to determine which semantic tags are likely to be associated with the given sound.

We can further refine this analysis by computing a term frequency-inverse document frequency (TF-IDF) statistic for each symbol (or word), and then weighting the vector component for the symbol (or word) based on the statistic. Note that this TF-IDF weighting factor increases proportionally with the number of times a symbol appears in the sound, but is offset by the frequency of the symbol across all of the sounds. This helps to adjust for the fact that some symbols appear more frequently in general.

We can also smooth out the histogram for each sound by applying a “confusion matrix” to the sequence of symbols. This confusion matrix says that if a given symbol A exists in a sequence of symbols, there is a probability (based on a preceding pattern of symbols) that the symbol is actually a B or a C. We can then replace one value in the row for the symbol A with corresponding fractional values in the rows for symbols A, B and C, wherein these fractional values reflect the relative probabilities for symbols A, 13 and C.

We can also perform a “topic analysis” on a sequence of symbols to associate runs of symbols in the sequence with specific topics. Topic analysis assumes that the symbols are generated by a “topic,” which comprises a stochastic model that uses probabilities (and conditional probabilities) for symbols to generate the sequence of symbols.

### Process of Recognizing Sound Event

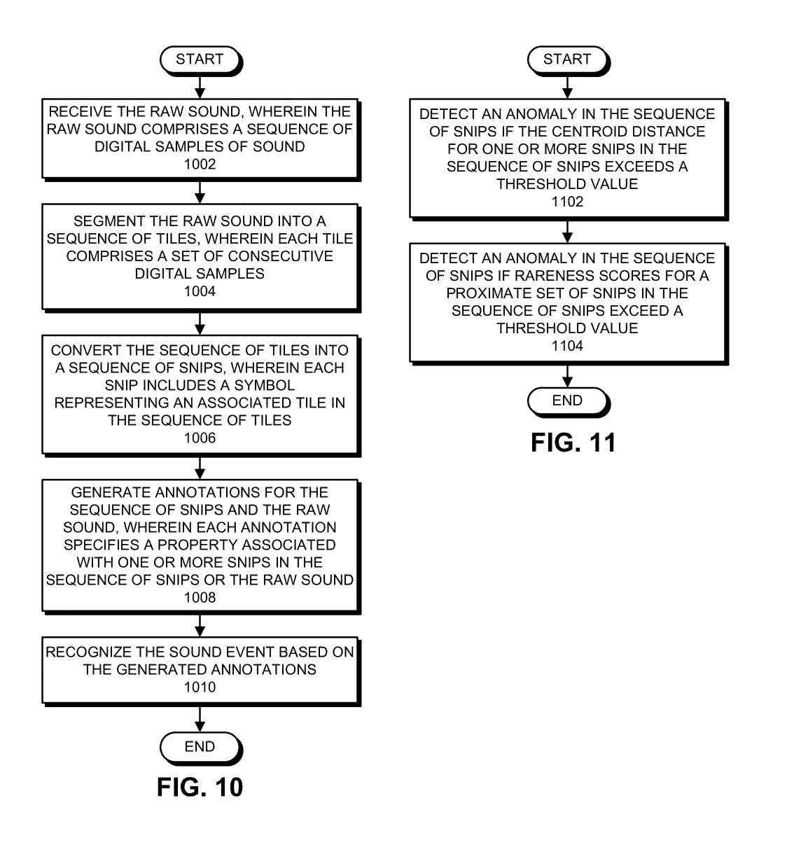

FIG. 10 presents a flow chart illustrating the process of recognizing a sound event in accordance with the disclosed embodiments. During operation, the system receives the raw sound, wherein the raw sound comprises a sequence of digital samples of sound (step 1002). Next, the system segments the raw sound into a sequence of tiles, wherein each tile comprises a set of consecutive digital samples (step 1004). The system then converts the sequence of tiles into a sequence of snips, wherein each snip includes a symbol representing an associated tile in the sequence of tiles (step 1006). Next, the system generates annotations for the sequence of snips and the raw sound, wherein each annotation specifies a property associated with one or more snips in the sequence of snips or the raw sound (step 1008). Finally, the system recognizes the sound event based on the generated annotations (step 1010).

### Process of Detecting an Anomaly

FIG. 11 presents a flow chart illustrating the process of detecting an anomaly in accordance with the disclosed embodiments. The system detects an anomaly in the sequence of snips if the centroid distance for one or more snips in the sequence of snips exceeds a threshold value (step 1102). Note that if the centroid distance measurements indicate that feature vectors commonly diverge from associated snip symbols, the system can add additional symbols to take care of these outliers. The system also detects an anomaly in the sequence of snips if rareness scores for a proximate set of snips in the sequence of snips exceed a threshold value (step 1104).

### Extensions

In some embodiments, instead of a snip being associated with a single symbol, a snip can be associated with several symbols indicating a likelihood that the feature vector for the snip maps to each symbol. For example, a snip may be assigned an 80% probability of being associated with the symbol A, a 15% probability of being associated with the symbol B and a 5% probability of being associated with the symbol C. We can do this for each snip in a sequence of snips, thereby recovering some of the numerical subtlety that existed in the corresponding feature vectors. Then, when the system subsequently attempts to match a sequence of snips with a pattern of symbols, the match can be a probabilistic match.

In some embodiments, the system attempts to account for the mixing of sounds by associating symbols with the mixed sounds. For example, suppose when a first sound associated with a symbol A mixes with a second sound associated with a symbol C, the resulting mixed sound will be associated with a symbol Z. In this case, the system accounts for this mixing based on the probability that the first sound will mix with the second sound.

In some embodiments, the system uses an iterative process to generate an accurate model for detecting sounds. For example, suppose the system seeks to discriminate among the sound of a plane, the sound of a blower and the sound of a siren. First, a user listens to a collection of sounds of planes, blowers and sirens and explicitly marks the sounds as planes, blowers and sirens. Once the user has identified an initial set of sounds as being associated with planes, blowers and sirens, the system helps the user look through a database to find other similar sounds, and the user marks these similar sounds as being planes, blowers and sirens. With every sound that is marked, the model gets progressively more precise. Then, when a sufficient number of planes, blowers and sirens have been marked, the system looks for patterns to identify common pathways through the snips and snip words and associated annotations to the planes, sirens and blowers. These common pathways can be used to facilitate subsequent sound-recognition operations involving planes, sirens and blowers.

Various modifications to the disclosed embodiments will be readily apparent to those skilled in the art, and the general principles defined herein may be applied to other embodiments and applications without departing from the spirit and scope of the present invention. Thus, the present invention is not limited to the embodiments shown, but is to be accorded the widest scope consistent with the principles and features disclosed herein.

The foregoing descriptions of embodiments have been presented for purposes of illustration and description only. They are not intended to be exhaustive or to limit the present description to the forms disclosed. Accordingly, many modifications and variations will be apparent to practitioners skilled in the art. Additionally, the above disclosure is not intended to limit the present description. The scope of the present description is defined by the appended claims.

1. A method for recognizing a sound event in raw sound, comprising:
receiving the raw sound, wherein the raw sound comprises a sequence of digital samples of sound;
segmenting the raw sound into a sequence of tiles, wherein each tile comprises a set of consecutive digital samples;
converting the sequence of tiles into a sequence of snips, wherein each snip includes a symbol representing an associated tile in the sequence of tiles, wherein each snip takes up less space than an associated tile, wherein each snip is stored in a canonical representation, and wherein the sequence of snips is searchable;
generating annotations for the sequence of snips and the raw sound, wherein each annotation specifies a property associated with one or more snips in the sequence of snips or the raw sound; and
recognizing the sound event based on the generated annotations.

2. The method of claim 1, wherein converting the sequence of tiles into the sequence of snips comprises:
identifying tile features for each tile in the sequence of tiles;
performing a clustering operation based on the tile features to identify clusters of tiles and to associate each tile with a cluster;
associating each identified cluster with a unique symbol; and
representing the sequence of tiles as a sequence of symbols representing clusters, wherein the symbols are associated with individual tiles in the sequence of tiles.

3. The method of claim 1, wherein the sequence of tiles includes one or more of the following:
overlapping tiles;
non-overlapping tiles;
tiles having variable sizes; and
one or more gaps between tiles in the sequence of tiles, wherein each gap comprises a segment of the raw sound that is not covered by a tile.

4. The method of claim 1, wherein annotating the sequence of snips involves:
generating grounded annotations, which are associated with specific segments of raw sound; and
generating higher-level annotations, which are associated with lower-level annotations.

5. The method of claim 1, wherein an annotation can include an acoustic annotation, which specifies an acoustic property associated with a sound feature.

6. The method of claim 1, wherein an annotation can include a semantic tag.

7. The method of claim 6, wherein an annotation can include a higher-level semantic tag, which is associated with one or more lower-level semantic tags.

8. The method of claim 1, wherein recognizing the sound event based on the generated annotations additionally involves considering other sensor inputs, which are associated with the raw sound.

9. The method of claim 1,
wherein an annotation for each snip includes a centroid distance parameter, which specifies a distance between a feature vector for a tile associated with the snip and a mean feature vector for all tiles associated with the snip; and
wherein the method further comprises detecting an anomaly in the sequence of snips if the centroid distance for one or more snips in the sequence of snips exceeds a threshold value.

10. The method of claim 1,
wherein an annotation for each snip includes a rareness score that specifies a rareness of the snip; and
wherein the method further comprises detecting an anomaly in the sequence of snips if rareness scores for a proximate set of snips in the sequence of snips exceed a threshold value.

11. A non-transitory computer-readable storage medium storing instructions that when executed by a computer cause the computer to perform a method for recognizing a sound event in raw sound, the method comprising:
receiving the raw sound, wherein the raw sound comprises a sequence of digital samples of sound;
segmenting the raw sound into a sequence of tiles, wherein each tile comprises a set of consecutive digital samples;
converting the sequence of tiles into a sequence of snips, wherein each snip includes a symbol representing an associated tile in the sequence of tiles wherein each snip takes up less space than an associated tile, wherein each snip is stored in a canonical representation, and wherein the sequence of snips is searchable;
generating annotations for the sequence of snips and the raw sound, wherein each annotation specifies a property associated with one or more snips in the sequence of snips or the raw sound; and
recognizing the sound event based on the generated annotations.

12. The non-transitory computer-readable storage medium of claim 11, wherein converting the sequence of tiles into the sequence of snips comprises:
identifying tile features for each tile in the sequence of tiles;
performing a clustering operation based on the tile features to identify clusters of tiles and to associate each tile with a cluster;
associating each identified cluster with a unique symbol; and
representing the sequence of tiles as a sequence of symbols representing clusters, wherein the symbols are associated with individual tiles in the sequence of tiles.

13. The non-transitory computer-readable storage medium of claim 11, wherein the sequence of tiles includes one or more of the following:
overlapping tiles;
non-overlapping tiles;
tiles having variable sizes; and
one or more gaps between tiles in the sequence of tiles, wherein each gap comprises a segment of the raw sound that is not covered by a tile.

14. The non-transitory computer-readable storage medium of claim 11, wherein annotating the sequence of snips involves:
generating grounded annotations, which are associated with specific segments of raw sound; and
generating higher-level annotations, which are associated with lower-level annotations.

15. The non-transitory computer-readable storage medium of claim 11, wherein an annotation can include an acoustic annotation, which specifies an acoustic property associated with a sound feature.

16. The non-transitory computer-readable storage medium of claim 11, wherein an annotation can include a semantic tag.

17. The non-transitory computer-readable storage medium of claim 16, wherein an annotation can include a higher-level semantic tag, which is associated with one or more lower-level semantic tags.

18. The non-transitory computer-readable storage medium of claim 11, wherein recognizing the sound event based on the generated annotations additionally involves considering other sensor inputs, which are associated with the raw sound.

19. The non-transitory computer-readable storage medium of claim 11,
wherein an annotation for each snip includes a centroid distance parameter, which specifies a distance between a feature vector for a tile associated with the snip and a mean feature vector for all tiles associated with the snip; and
wherein the method further comprises detecting an anomaly in the sequence of snips if the centroid distance for one or more snips in the sequence of snips exceeds a threshold value.

20. The non-transitory computer-readable storage medium of claim 11,
wherein an annotation for each snip includes a rareness score that specifies a rareness of the snip; and
wherein the method further comprises detecting an anomaly in the sequence of snips if rareness scores for a proximate set of snips in the sequence of snips exceed a threshold value.

21. A system that recognizes a sound event in raw sound, comprising:
at least one processor and at least one associated memory; and
a sound-event-recognition mechanism that executes on the at least one processor, wherein during operation, the sound-event-recognition mechanism:
segments the raw sound into a sequence of tiles, wherein each tile comprises a set of consecutive digital samples;
converts the sequence of tiles into a sequence of snips, wherein each snip includes a symbol representing an associated tile in the sequence of tiles, wherein each snip takes up less space than an associated tile, wherein each snip is stored in a canonical representation, and wherein the sequence of snips is searchable;
generates annotations for the sequence of snips and the raw sound, wherein each annotation specifies a property associated with one or more snips in the sequence of snips or the raw sound; and
recognizes the sound event based on the generated annotations.

22. The system of claim 21, wherein while converting the sequence of tiles into the sequence of snips, the sound-event-recognition mechanism:
identifies tile features for each tile in the sequence of tiles;
performs a clustering operation based on the tile features to identify clusters of tiles and to associate each tile with a cluster;
associates each identified cluster with a unique symbol; and
represents the sequence of tiles as a sequence of symbols representing clusters, wherein the symbols are associated with individual tiles in the sequence of tiles.

23. The system of claim 21, wherein the sequence of tiles includes one or more of the following:
overlapping tiles;
non-overlapping tiles;
tiles having variable sizes; and
one or more gaps between tiles in the sequence of tiles, wherein each gap comprises a segment of the raw sound that is not covered by a tile.

24. The system of claim 21, wherein while annotating the sequence of snips, the sound-event-recognition mechanism:
generates grounded annotations, which are associated with specific segments of raw sound; and
generates higher-level annotations, which are associated with lower-level annotations.

25. The system of claim 21, wherein an annotation can include an acoustic annotation, which specifies an acoustic property associated with a sound feature.

26. The system of claim 21, wherein an annotation can include a semantic tag.

27. The system of claim 26, wherein an annotation can include a higher-level semantic tag, which is associated with one or more lower-level semantic tags.

28. The system of claim 21, wherein while recognizing the sound event based on the generated annotations, the sound-event-recognition mechanism additionally involves considering other sensor inputs, which are associated with the raw sound.

29. The system of claim 21,
wherein an annotation for each snip includes a centroid distance parameter, which specifies a distance between a feature vector for a tile associated with the snip and a mean feature vector for all tiles associated with the snip; and
wherein the sound-event-recognition mechanism additionally detects an anomaly in the sequence of snips if the centroid distance for one or more snips in the sequence of snips exceeds a threshold value.

30. The system of claim 21, wherein an annotation for each snip includes a rareness score that specifies a rareness of the snip; and
wherein the sound-event-recognition mechanism additionally detects an anomaly in the sequence of snips if rareness scores for a proximate set of snips in the sequence of snips exceed a threshold value.
